(19) United States
(12) Patent Application Publication
(10) Pub. No.: US 2005/0169697 A1
(43) Pub. Date: Aug. 4, 2005

(54) Adjustable shaft connector

(75) Inventor: Daniel Joseph Butkievich, Oxford, CT (US)

Correspondence Address: Mark A. Ussai;Michael Best & Friedrich LLP, Suite 360, 3773 Corporate Parkway, Center Valley, PA, 18034, US

(73) Assignee: TIMKEN US CORPORATION, Torrington, CT (US)

(21) Appl. No.: 10/771,033

(22) Filed: Feb. 3, 2004

(51) Int. Cl. F16D 3/00

(52) U.S. Cl. 403/57

(57) ABSTRACT

A shaft connector assembly connects a first shaft with a second shaft and includes a body having a portion connectable with the first shaft, a channel configured to receive a portion of the second shaft, a first opening into the channel and a second opening into the channel generally aligned with the first opening. A retainer is disposed within the first opening and has a bore and a rod is disposable through the second opening, has a longitudinal axis and is engageable with the retainer bore. The rod displaces the retainer along the rod axis and/or rotates the retainer about the axis such that the retainer contacts the second shaft to retain the second shaft portion disposed within the body channel. Specifically, the retainer has a clamp surface that pushes against the second shaft at a position spaced from the rod axis by a substantial distance along the shaft centerline.

### BACKGROUND OF THE INVENTION

The invention relates to shaft connecting devices, and more particularly to devices for connecting automotive steering shafts.

Numerous devices for connecting together or coupling two shafts, and particularly steering wheel shafts, are known. One type of shaft connector assembly particularly suited for use in current automotive assembly procedures is commonly referred to as a “slap yoke” connector. A slap yoke connector includes a clamp body connected with a first shaft and a U-shaped yoke body having a channel for receiving a second shaft. The first shaft is installed into the steering assembly with the clamp body attached to a lower end thereof, and then the second shaft is installed into the assembly by “slapping” an end of the second shaft upwardly so that a portion of the second shaft enters into the shaft channel of the yoke body. Then, an assemblyperson installs a bolt or similar device through a pair of parallel sidewalls of the yoke body so as to extend across and retain the shaft portion within the yoke body.

Although the described slap-yoke shaft connectors have been generally useful, these connector assemblies have certain limitations. One limitation is that known shaft connectors generally do not satisfactorily connect shafts when the second shaft has a thickness outside of a desired tolerance. Generally, the connector bolt has to engage with a proximal outer surface of the shaft while an opposing shaft surface is disposed against the yoke basewall i.e., the wall portion connecting the two parallel sidewalls). If the thickness dimension is below a desired minimum value, the bolt may not engage the proximal shaft surface, such that the shaft portion is able to slide out of the yoke channel. Further, if the thickness dimension is too large such that the shaft extends across a portion of the sidewall holes, the bolt cannot enter the yoke channel to retain the shaft therewithin.

In view of the foregoing, it is desirable to have a shaft connector that is capable of retaining shafts of various sizes or thickness. Further, it is desirable to provide such a shaft that facilitates assembly and is cost-effective to manufacture.

### SUMMARY OF THE INVENTION

In a first aspect, the present invention is a shaft connector for connecting a first shaft with a second shaft. The shaft connector comprises a yoke body having an end portion connectable with the first shaft and a channel configured to receive a portion of the second shaft. The yoke body also has a first opening into the channel and a second opening into the channel and generally aligned with the first opening. A retainer is at least partially disposed within the first opening and has a bore. Further, a rod (e.g., a threaded fastener) is disposable through the second opening, has a longitudinal axis and is engageable with the retainer bore so as to displace the retainer along the rod axis. Alternatively, the rod rotates the retainer about the rod axis such that the retainer contacts the second shaft to retain the second shaft portion disposed within the yoke channel.

In a second aspect, the present invention is also a shaft connector for connecting a first shaft with a second shaft, the second shaft having an outer surface and a longitudinal centerline. The shaft connector comprises a yoke body having an end portion connectable with the first shaft, a channel configured to receive a portion of the second shaft, and a wall with an opening. A threaded rod is disposable through the yoke opening and has a longitudinal axis. Further, a retainer has a threaded bore, a longitudinal axis extending through the bore, and a clamp surface spaced radially from the retainer axis. The bore is threadably engageable by the rod such that the rod axis is generally collinear with the retainer axis and rotation of the rod about the rod axis causes the clamp surface to push against the second shaft outer surface so as to retain the second shaft portion disposed within the yoke channel. The clamp surface contacts the shaft outer surface at a position spaced from the rod axis by a distance generally along the second shaft centerline.

### BRIEF DESCRIPTION OF THE DRAWINGS

The foregoing summary, as well as the detailed description of the preferred embodiments of the invention, will be better understood when read in conjunction with the appended drawings. For the purpose of illustrating the invention, there is shown in the drawings, which are diagrammatic, embodiments that are presently preferred. It should be understood, however, that the invention is not limited to the precise arrangements and instrumentalities shown. In the drawings:

FIG. 1 is a broken-away, side perspective view of a shaft connector assembly of the present invention, shown retaining a second shaft and having a retainer formed with a first body structure;

FIG. 2 is a front cross-sectional view of the shaft connector;

FIG. 3 is a side elevational view of the shaft connector, shown connecting first and second shafts;

FIG. 4 is an enlarged side perspective view of a yoke body having a retainer opening formed by a first preferred contour surface;

FIG. 5 is a side perspective view, taken from the top, of the retainer with the first body structure;

FIG. 6 is a side perspective view, taken from the bottom, of a retainer formed with a second body structure;

FIG. 7 is side plan view of the retainer with the first body structure;

FIG. 8 is side plan view of the retainer with the second body structure;

FIG. 9 is a front cross-sectional view of the yoke body, shown with a first body structure retainer disposed in the retainer opening and with a threaded rod entering the retainer bore;

FIG. 10 is a front plan view of the yoke body, shown with a second body structure retainer as displaced into the retainer opening by a second shaft portion entering the yoke channel;

FIG. 11 is a partially broken-away side elevational view of the shaft connector assembly, shown with a first body structure retainer disposed above a second shaft portion;

FIG. 12 is a partially broken-away side elevational view of the shaft connector assembly, shown with a second body structure retainer disposed above a second shaft portion;

FIG. 13 is a partially broken-away side elevational view of the shaft connector assembly, shown with a first body structure retainer retaining a second shaft portion with a first thickness dimension; and

FIG. 14 is a partially broken-away side elevational view of the shaft connector assembly, shown with a first body structure retainer retaining a second shaft portion with a second thickness dimension.

### DETAILED DESCRIPTION OF THE INVENTION

Certain terminology is used in the following description for convenience only and is not limiting. The words “inner” “inwardly” and “outer”, “outwardly” refer to directions toward and away from, respectively, a designated inner surface of a yoke body channel or a designated axis/centerline of a specific shaft or other component of a shaft connector, the particular meaning intended being readily apparent from the context of the description. Further, the term “circumferential” refers to elements that are oriented so as to be partially or completely extending about or around a designated axis, centerline or center of the shaft connector. The terminology includes the words specifically mentioned above, derivatives thereof, and words or similar import.

Referring now to the drawings in detail, wherein like numbers are used to indicate like elements throughout, there is shown in FIGS. 1-14 a presently preferred embodiment of an adjustable shaft connector 10 for connecting a first shaft 1 with a second shaft 2, the second shaft 2 having an outer surface 3 and a longitudinal centerline 4. The shaft connector 10 basically comprises a yoke body 12, a retainer 14 and a threaded rod 16. The yoke body 12 has an end portion 15 connectable with the first shaft 1 and two spaced apart walls or sidewalls 18A, 18B defining a channel 20 configured to receive a portion 2a of the second shaft 2. One of the two yoke walls 18A has a first or “retainer” opening 22 and the other one of the two walls 18B has a second or “rod” opening 24 generally aligned with the first opening 22. The retainer 14 is at least partially disposed within the yoke retainer opening 22 and has a threaded bore 26, a longitudinal axis 28 extending through the bore 26, such that the bore 26 is generally centered about the axis 28, and a clamp surface 30 spaced radially from the retainer axis 28 (i.e., perpendicularly from the axis 28).

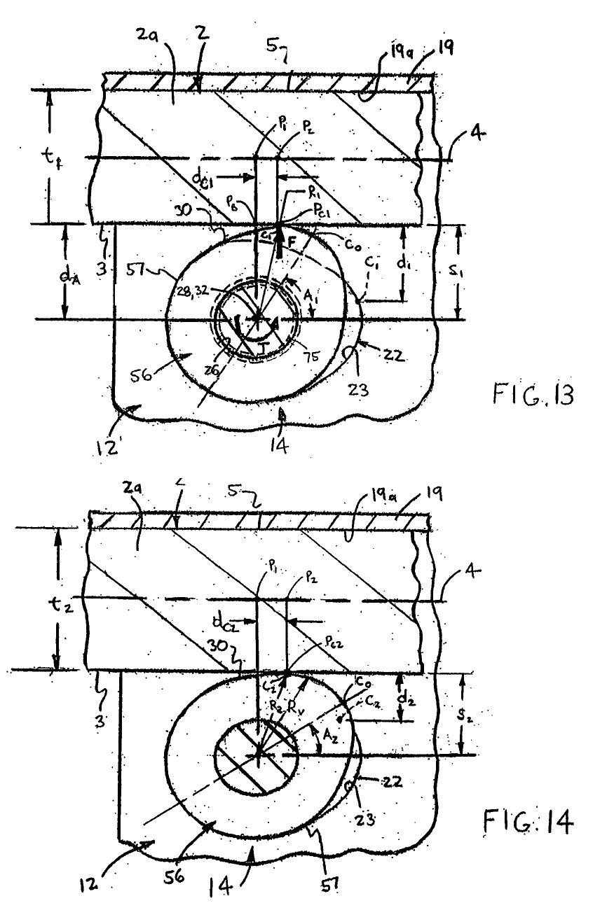

Further, the threaded rod 16 is disposable through the yoke rod opening 24 and has a longitudinal axis 32. The rod 16 is threadably engageable with the retainer bore 26 so that the rod axis 32 is generally collinear with the retainer axis 28. When the rod 16 is engaged within the bore 26, rotation of the rod 16 displaces the retainer 14 along the rod axis 32 and/or rotates the retainer 14 about the rod axis 32, causing the retainer 14 to contact the shaft 2 to thereby retain the second shaft portion 2a disposed within the yoke channel 20. More specifically, rotation of the rod 16 about the rod axis 32 causes the retainer clamp surface 30 to push against the second shaft outer surface 3, thereby retaining or “clamping” the second shaft portion 2a within the channel 20. In other words, torque T (FIG. 13) applied to the rod 16 (i.e., by a wrench, etc.) is transmitted to the retainer 14 to cause the clamp surface 30 to push against the shaft outer surface 3 with a clamping force F (FIG. 13) in a direction generally normal to the shaft outer surface 3, as discussed in greater detail below.

Referring to FIGS. 13 and 14, the clamp surface 30 contacts the shaft outer surface 3 at a position P_{C} spaced from the rod axis 32 by a “substantial” (i.e., not insignificant or negligible) distance d_{C} generally along the second shaft centerline 4. In other words, the rod axis 32 is spaced perpendicularly from a first position P₁ on the second shaft centerline 4 and the clamp surface 30 engages the shaft outer surface 3 at a point of contact P_{C} (i.e., P_{C1} in FIG. 13; P_{C2} in FIG. 14) spaced perpendicularly from a second position P₂ on the second shaft centerline 4, the first and second positions P₁, P₂ being spaced apart axially along the centerline 4. With the described configuration of the connector assembly 10, the retainer 14 is adjustably positionable at various rotational or angular locations/positions about the rod axis 32 in order to enable the clamp surface 30 to retainably contact different second shafts 2 of various sizes, as discussed in further detail below.

Referring now to FIGS. 1-4, the yoke body 12 is preferably formed as a conventional “slap” yoke body generally known in the automotive industry for connecting together two steering shaft sections of a steering wheel assembly (not shown). The yoke body 12 preferably includes first and second U-shaped body portions 13A, 13B integrally formed and arranged such that the two U-shapes are oriented generally orthogonal to each other. The first body portion 13A includes the two sidewalls 18A, 18B and a base wall 19 extending between and connecting the two sidewalls 18A, 18B such that the first body portion 13A is generally shaped as an enclosed “U”. The three walls 18A, 18B and 19 define the yoke channel 20, with a structure suitable to receive the second shaft portion 2a, and a U-shaped outer opening 17 (FIG. 10) into the channel 20 through which the second shaft 2 extends when retained within the connector assembly 10, as discussed below. The yoke channel 20 is configured to separately receive a portion 2a of each one of a plurality of second shafts 2, as discussed below. Further, the free ends of the two sidewalls 18A, 18B define a generally rectangular lower opening 21 into the yoke channel 20. Furthermore, the base wall 19 preferably has a concave inner base surface 19a shaped to conform to a convex outer surface of the second shaft 2, as discussed below.

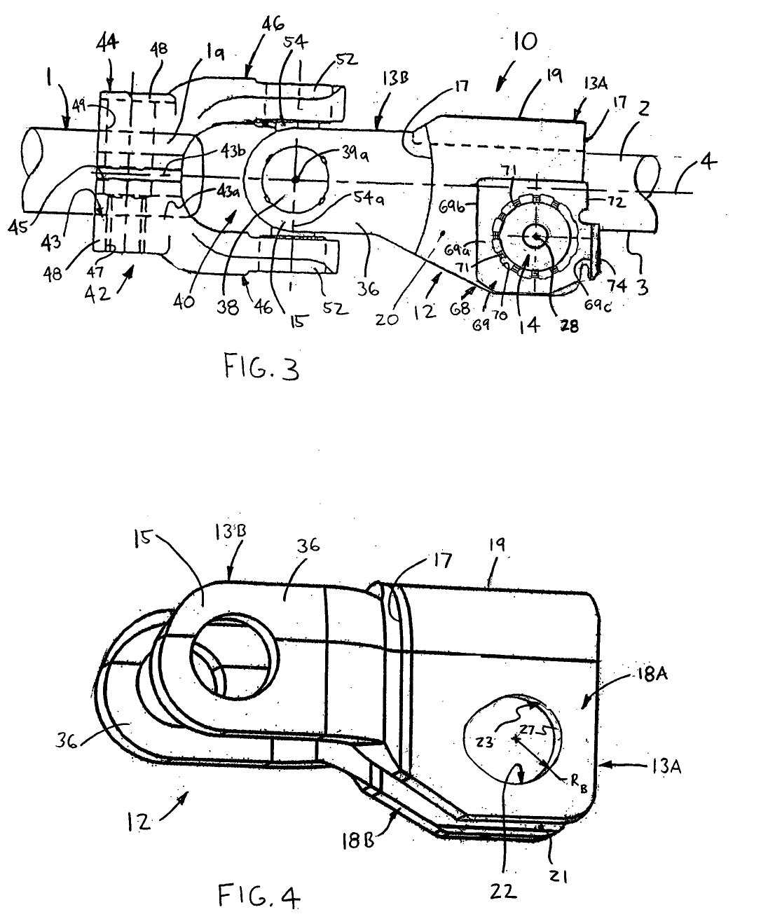

Referring to FIGS. 4 and 12, the retainer opening 22 of the yoke body 12 is configured to permit a first, “clamp” portion 56 (described below) of the retainer 14 to slidably displace through the opening 22 and to alternatively permit a second, “shaft” portion 58 (described below) of the retainer 14 to rotate or rotatably displace within the opening 22. As discussed in detail below, the retainer 14 preferably has a body 62 that may be formed having either one of two presently preferred body structures 64 or 66. Each body structure 64 and 66 has the same basic clamp, shaft and head portions 56, 58 and 60, respectively, but differ as to the relative sizing and specific shapes of the clamp portion 56 and head portion 58, as discussed in detail below.

In order to function as desired with a specific retainer body structure 64 or 66, the retainer opening 22 is preferably formed or defined by one of two different boundary or “contour” surfaces 23 or 25. More specifically, the contour surfaces 23 and 25 each extend through the sidewall 18A of a particular yoke body 12 and have a distinct shape that is different than the other contour surface 25, 23, respectively. The specific shape and size of each contour surface 23, 25 of the yoke retainer opening 22 generally corresponds to a radially-outermost perimeter surface of the associated retainer body structure 64, 66, respectively, as discussed in detail below. Further, the second, rod opening 24 of the yoke body 12 is preferably formed as a generally circular through-hole extending through the associated sidewall 18B and sized to provide a clearance fit for the threaded rod 16, as discussed below. Also, an annular surface section surrounding the rod opening 24 provides a pressure surface 21 against which a head of the threaded rod 16 clamps when the rod 16 transmits torque to the retainer 14, as discussed in further detail below.

Referring specifically to FIG. 4, in the first preferred configuration, the retainer opening 22 has a generally oblong contour surface 23 that substantially corresponds in shape to an oblong cross-sectional shape of the clamp portion 56 of the retainer first body structure 64, as discussed in further detail below. Further, the first contour surface 23 is sized slightly larger than an outer circumferential surface 57 of the retainer clamp portion 56, as described below. As such, the clamp portion 56 is slidably displaceable through the opening 22, specifically along the collinear retainer and rod axes 28 and 32, respectively, but is prevented from rotating within the retainer opening 22, for reasons discussed below. Furthermore, the oblong contour 23 has a partial circular section (i.e., does not define a complete circle) with a constant radius RB that provides a bearing surface 27 configured to rotatably support the retainer shaft portion 58, as is also described below.

Referring particularly to FIG. 12, in the second preferred configuration, the retainer opening 22 has a substantially circular second contour surface 25 that is sized slightly larger than the shaft portion 58 of the second retainer body structure 66. More specifically, the second contour surface 25 has a generally constant radius R_{C} about a center C of the opening 22, the retainer axis 28 extending through the center C when the retainer 14 is disposed within the retainer opening 22. Due to the relative sizing of the clamp portion 56 and the shaft portion 58 of the retainer second body structure 66, the clamp portion 56 is able to displace through and, although not preferred, to rotate within the second contour surface 25. As such, for proper positioning of the retainer 14, the retainer 14 having the retainer second body structure 66 is spring-biased so to generally locate the clamp portion 56 within the yoke channel 20 and the shaft portion 58 within the retainer second contour surface 25, for reasons described in detail below. Further, the opening 22 having the second contour surface 25 is “radially larger” (i.e., is located a greater radial distance from the opening geometric center (not indicated)) than the first contour surface 23. As such, an innermost section 25a of the contour surface 25 is located more proximal to the base surface 19a than is the outer surface 3 of a second shaft 2 disposed within the channel 20, for reasons discussed below.

Referring now to FIGS. 3 and 4, the second U-shaped body portion 13B of the yoke 12 provides the yoke end portion 16 as discussed above. The second U-shaped portion is preferably formed of two spaced-apart arms 36, each arm 36 extending from an edge of a separate one of the sidewalls 18A, 18B so as to be generally parallel with the other arm 36. Preferably, the arms 36 are each offset outwardly with respect to the connected sidewall 18 such that the spacing between the arms 36 is greater than the spacing between the sidewalls 18. Further, each arm 36 includes a bearing 38 and a shaft (not shown) extends between and into each of the aligned bearings 38 (only one shown) such that the arms 36, bearings 38 and the shaft form a first half of a U-joint 40, as discussed in further detail below.

Referring specifically to FIG. 3, the shaft connector assembly 10 preferably further comprise a clamp body 42 attached to the end portion 16 of yoke body 12. The clamp body 42 is connectable to the first shaft 1 such that the first and second shafts 1, 2, respectively, are coupled or connected together when the first shaft 1 is attached to the clamp body 12 and the second shaft portion 2a is retained in the yoke channel 20. Preferably, the clamp body 12 is rotatably attached to the yoke body end portion 16 such that the second shaft 2 is adjustably positionable with respect to the first shaft 1. Most preferably, the yoke body 12 and the clamp body 42 are rotatably attached by means of the U-joint 40 (i.e., formed of portions of each body 12, 42, as described above and in further detail below), such that both rotational motion and torque are transferable from the first shaft 1 to the second shaft 2 through the shaft connector assembly 10.

The clamp body 42 is preferably formed of a generally circular, ring-like base 44 and two spaced apart arms 46 extending from the base 44 and forming a second half of the U-joint 40. The base 44 has a central opening 43 defined by an inner circumferential grip surface 43a and having a central axis 43b. The opening 43 is sized to receive a portion 1a of the first shaft 1 such that the grip surface 43a extends about the outer surface of the shaft portion 1a and the shaft portion 1a is disposed along the central axis 43b. Further, a slot or gap 45 extends radially from the opening 43 and through the base 44 so as to form two spaced apart clamp arm portions 48. One clamp arm portion 48 has a threaded hole or bore 47 and the other clamp arm portion 48 has a through hole 49, the two hole 47, 49 being threaded bores 47 being aligned with each other. Furthermore, a threaded rod (not shown), such as a conventional bolt, extends through the through hole 49 and is threadably engageable with the threaded bore 47 to cause the two clamp arm portions 48 to become disposed against each other, thereby closing the gap 45. The closing of the radially extending gap 45 causes the circumferential grip surface 43a to closely contact or engage the outer surface of the shaft portion 1a, thereby releasably attaching the clamp body 42 to the first shaft 1.

Still referring to FIG. 3, the two arms 46 of the clamp body 42 each have a bearing 52 and a shaft 54 extends between the aligned bearings such that the arms 46, bearings 52, and shaft 54 form a second half of the U-joint 40. The yoke shaft (not shown) and the clamp shaft 54 are connected together at each shaft center so as connect the first and second halves of the U-joint 40, the two shafts 54 (only one shown) and the two pairs of arms 36 and 46 extending substantially perpendicularly with respect to each other. With this arrangement, the yoke body 12 is rotatably connected with the clamp body 42 so as to be separately pivotable about two perpendicular axes 39a, 54a extending longitudinally through each shaft 39, 54, respectively. As such, the first and second shafts 1 and 2 are also pivotable with respect to each other about the two axes 39a, 54a when the first shaft 1 is connected with the clamp body 42 and the second shaft 2 is connected with the yoke body 12.

Although the above-described structures of the yoke and clamp bodies 12, 42 are presently preferred, it is within the scope of the present invention to construct either or both of these components of the shaft connector assembly 10 in any other appropriate manner and/or having any other appropriate shape. For example, the two bodies 12 and 42 may be pivotably connected so as to be rotatable about a single axis or may be non-movably or immovably connected such that the first and second shafts 1, 2, respectively, are rigidly coupled. Further for example, the clamp body 12 may have a threaded bore engaged about the first shaft 1 in the manner of an end cap (not shown), be attached to the first shaft 1 by means of a bolt, or retained on the shaft 1 with a set screw. As yet another example, the shaft connector assembly 10 may be constructed without the clamp body 42, in which case the end portion 15 of the yoke body 12 will be configured to attach directly onto the first shaft 1. The scope of the present invention encompasses these and all other appropriate structures of the yoke body 12 and clamp body 42 that enables the shaft connector assembly 10 to function as generally described herein.

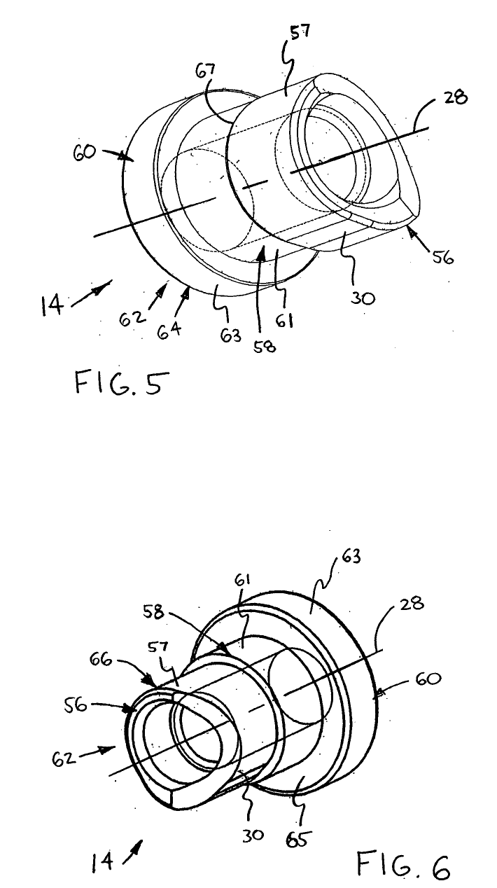

Referring now to FIGS. 5-12, the retainer 14 basically includes at least a first, clamp portion 56 and a second, shaft portion 58 spaced from the clamp portion 56 along the retainer axis 28, as mentioned above. Preferably, the retainer 14 further includes a head portion 60 spaced from the shaft portion 58 along the axis 28 such that the shaft portion 58 is disposed or “sandwiched” between the clamp and head portions 56 and 60, respectively. Further, the retainer 14 is preferably constructed as a single, generally cylindrical body 62 in which the three portions 56, 58 and 60 are integrally formed, but may alternatively be provided by two or more separately connected pieces or components (not shown). As mentioned above, the retainer body 62 may be formed in at least two presently preferred alternative structures, a first body structure 64, shown in FIGS. 5, 7 and 11, or a second body structure 66, as depicted in FIGS. 6, 8 and 12. The two body structures 64 and 66 are generally similar, but differ from each other primarily by the relative sizes of the clamp portion 56 and the shaft portion 58. For the sake of clarity, the general structure of each of the three basic retainer portions or components 56, 58 and 60, common to both body structures 64 and 66, are first described before discussing the differences between the two structures 64, 66, as follows.

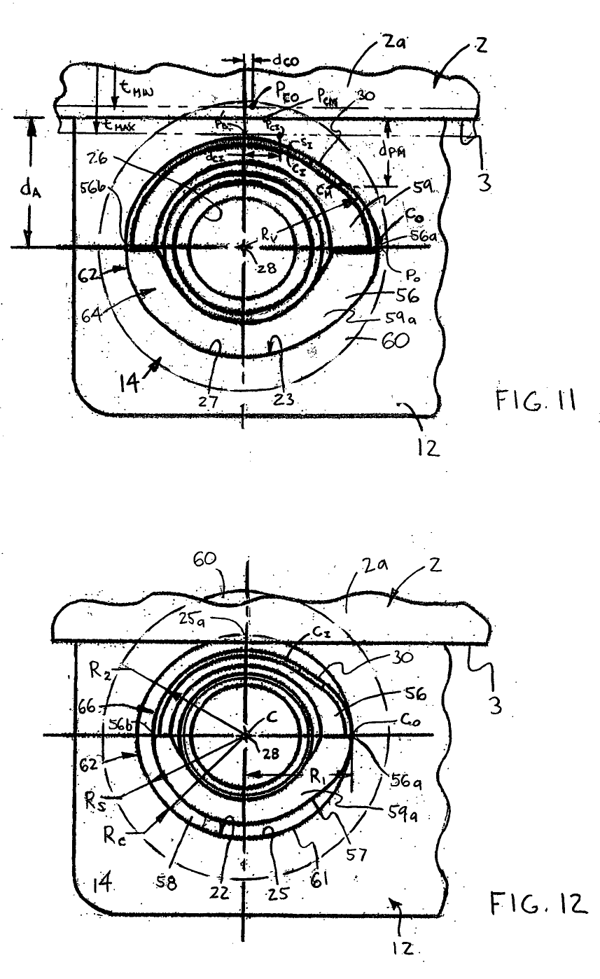

Preferably, the retainer clamp portion 56 includes an outer circumferential surface 57, which has a section providing the clamp surface 30, and an outer radial surface 59 located at a first end 62a of the body 62. The threaded retainer bore 26 extends into the clamp portion 56 from the radial surface 59, and preferably extends through the entire body 62 (i.e., through the shaft and head portions 58 and 60) to a body second end 62b. Preferably, the clamp portion 56 has an oblong cross-sectional shape within a plane(s) extending generally perpendicularly with respect to the retainer axis 28. Most preferably, the clamp portion 56 is shaped as a generally elliptical or ovular right cylinder; in other words, as a right cylinder having elliptical/oval-shaped cross-sections within plane(s) extending perpendicularly through the retainer axis 28, as best shown in FIGS. 11 and 12.

Due to the elliptical or oval shape, the clamp portion 56 provides a curved clamp surface 30 spaced from the retainer axis 28 by a varying radial distance R_{V}, as indicated in FIG. 11. More specifically, the clamp surface 30 extends from a radially-innermost point/section C₁, at which the radius R_{V} has a minimum value, and a radially-outermost point/section C₀ where the radius R_{V} has a maximum value, the radius R_{V} increasing generally continuously between the innermost and outermost positions P₁ and P₀. With such a clamp surface 30, rotation of the clamp portion 56 about the axis 28 in a first direction R₁ causes the clamp surface 30 to displace generally perpendicularly toward the shaft outer surface 3 until some point Cₙ on the clamp surface 30 (i.e., any point on the surface 3 including the inner and outermost points C₁ and C₀) contacts a point P_{C} on the shaft surface 3. As mentioned above and discussed in further detail below, the described structure of the clamp surface 30 provides the retainer 14 with the capability of retaining different sized shafts 2. Further, the clamp surface 30 is located more proximal to one lateral side 56a of the clamp portion 56 and the retainer bore 26 is eccentrically disposed within the clamp portion 56, such that the axis 28 is located more proximal to the other lateral side 56b, as shown in FIGS. 11 and 12. Such a structure provides a greater distance between the radially outermost point (designated as “P₀”) of the clamp surface 30 and the retainer axis 28 than would be possible if the bore 26 where more centrally located. This enables the clamp surface 30 to be potentially displaceable through a greater maximum distance, which also enhances the adjustability of the retainer 14, as described below.

Furthermore, the clamp portion 56 preferably has a chamfered or angled edge section 59a of the radial outer surface 59 that extends generally toward the shaft portion 58, which is provided for intially locating the shaft 2, as discussed below. In addition, for the second preferred body structure 66, the angled edge section 59a also provides a surface against which the second shaft 2 pushes the retainer 14 to displace laterally outwardly from the yoke channel 20, as discussed in further detail below.

Still referring to FIGS. 5-12, the retainer shaft portion 58 is preferably formed as a right circular cylinder or tube that is substantially centered about the retainer axis 28. More specifically, the shaft portion 58 has circular annular cross-sections within planes extending generally perpendicularly with respect to the axis 28, a substantially constant outside diameter D_{S} (and an outer radius R_{S}) at all positions along the axis 28, and a circular outer circumferential surface 61. With this structure, the shaft portion 58 is configured to rotatably support the retainer 14 when the threaded rod 16 drives the clamp portion 56 about the retainer axis 28, as discussed in further detail below. Specifically, when the retainer 14 is rotated, the shaft circular outer surface 61 slides generally against the opening circular inner surface 25/bearing section 27 such that the shaft portion 58 is substantially prevented from linearly displacing in directions perpendicular to the shaft outer surface 3. As such, the shaft portion 58 functions to maintain the retainer axis 28 at about a fixed distance d_{A} (see FIGS. 11 and 13) from the shaft outer surface 3 when the retainer 14 rotates about the axis 28, as described below.

Preferably, the head portion 60 is also formed as a right circular cylinder substantially centered about the retainer axis 28, but is sized radially larger than the shaft portion 58. More specifically, the head portion 60 has an outside diameter D_{H} that is substantially larger than the outside diameter D_{S} of the shaft portion 58. Further, the head portion 60 has an outer circumferential surface 63 spaced from the retainer axis 28 by a radius R_{H} (i.e., D_{H}/2) and a radial surface 65 extending between the shaft outer circumferential surface 61 and the head outer circumferential surface 63. The head radius R_{H} is greater than the magnitude of the radius R_{B} (FIG. 4) of the first contour bearing surface 27 or the radius R_{C} (FIG. 12) of the second contour surface 25, such that the head 60 is unable to enter the retainer opening 22. Instead, the head radial surface 65 seats against portions of the yoke wall outer surface surrounding the opening 22 (see. FIGS. 11 and 12) when the retainer 14 displaces into the yoke channel 20 along the rod axis 32, as discussed in further detail below.

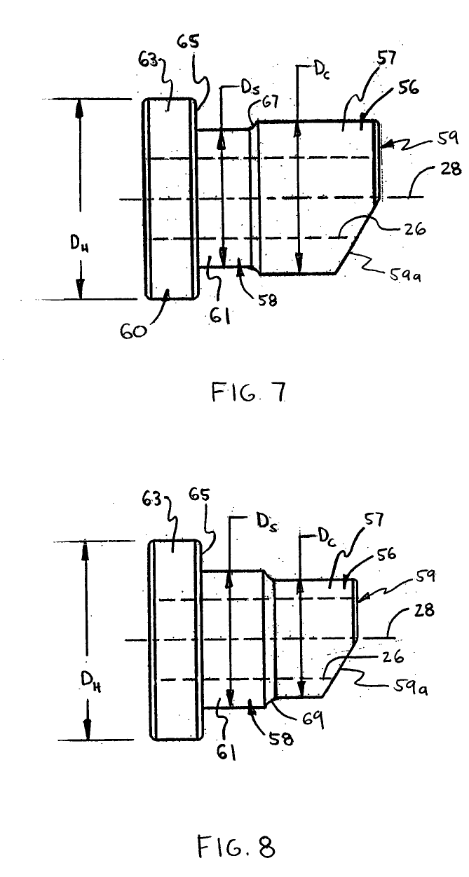

Having described the basic portions or components of the retainer 14, the differences between the first body structure 64 and the second body structure 66 of the retainer body 62 are now discussed as follows. Referring first to FIGS. 5, 7 and 11, the first body structure 64 is formed such that the clamp portion 56 is “radially larger” than the shaft portion 58. In other words, the clamp portion 56 is sized such that at least a portion of the clamp surface 30 is spaced from the retainer axis 28 by a radial distance(s) that is greater than the outer radius R_{S} of the shaft portion 58. Preferably, the entire outer surface 57 of the clamp portion 56 is offset radially outwardly with respect to the shaft portion outer surface 61, in other words, the radial distance between every point on the clamp outer surface 57 and the axis 28 is greater than the magnitude of the shaft outer radius R_{S}. Further, the clamp circumferential outer surface 57 and the shaft outer circumferential surface 61 are preferably connected by a chamfered or radiused circumferential surface section 67 extending both axially and generally radially inwardly from the clamp outer surface 57 to the shaft outer surface 61, as indicated in FIG. 7.

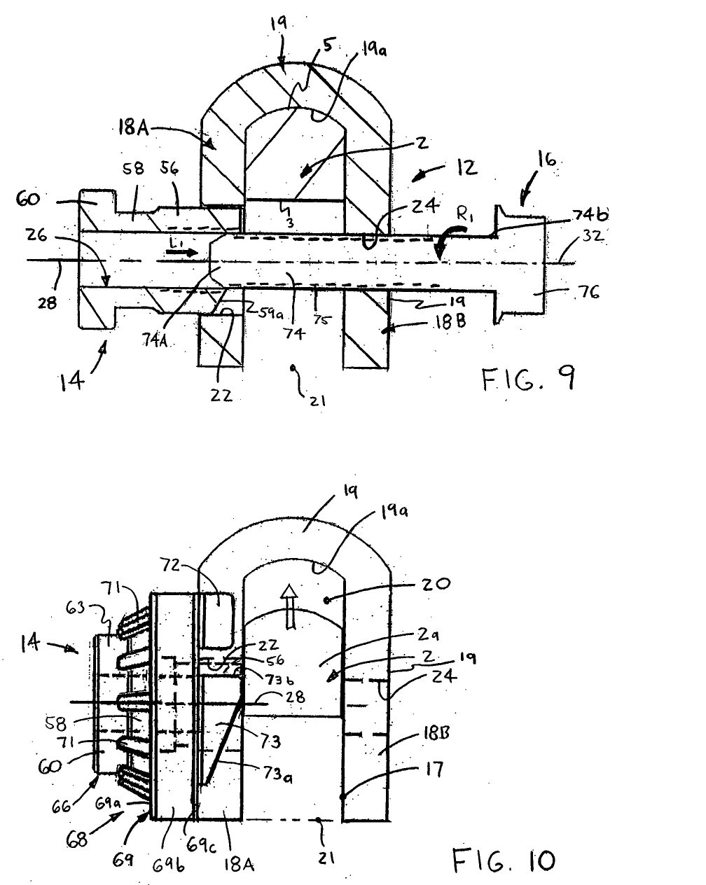

Referring to FIGS. 9 and 12, the retainer 14 having a body 62 formed with the first body structure 64 is preferably used in combination with a yoke body 12 having a retainer opening 22 formed with the first contour surface 23. As discussed above, the contour surface 23 is shaped to generally correspond to, but is sized slightly larger than, the outer circumferential surface 57 of the clamp portion 56. With such a combination of yoke body 12 and retainer 12, the clamp portion 56 is able to linearly displace or “slide” through the opening 22, but is prevented from rotating during such linear displacement. Preventing the clamp portion 56 from rotatably displacing within the opening 22 ensures that the clamp surface 30 is spaced above the shaft outer surface 3 when the clamp portion 56 becomes fully disposed within the yoke channel 20. Thereafter, as described in further detail below, the shaft portion 58 rotates or rotatably displaces within the bearing surface portion 27 of the first contour surface 23 as the clamp surface 30 linearly displaces into contact with the outer surface 3 of the second shaft 2 (e.g., see FIG. 13).

Referring now to FIGS. 6, 8, 10 and 12, the second body structure 66 is formed such that the shaft portion 58 is generally “radially larger” than the clamp portion 56, i.e., opposite the relative sizing of the first structure 64. More specifically, the radially-outermost section(s) of the clamp outer surface 57, specifically located at side 57a, is spaced from the retainer axis 28 by a radial distance R₁ that is preferably equal to, but no greater than, the shaft portion outer radius R_{S}, as best shown in FIG. 12. Further, the remainder of the clamp portion outer surface 57 is offset radially inwardly with respect to the shaft outer surface 61. In other words, the radial distance (e.g., R₂ in FIG. 12) between each of the remaining points on the clamp outer surface 57 and the retainer axis 28 is less than the magnitude of the shaft portion outer radius R_{S}. Further, the clamp outer surface 57 and the shaft outer surface 61 are preferably connected by a chamfered or radiused circumferential surface section 69 extending both axially and generally radially outwardly from the clamp outer surface 57 to the shaft outer surface 61, as indicated in FIG. 8.

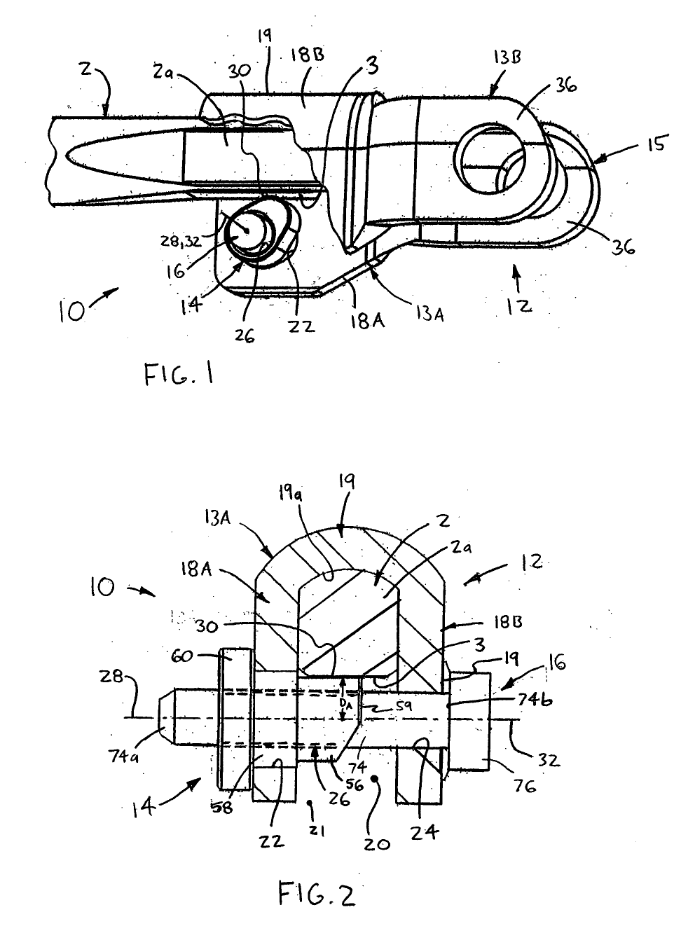

Referring to FIG. 12, the retainer 14 having a body 62 formed with the second body structure 64 is preferably used in combination with a yoke body 12 having a retainer opening 22 with the second contour surface 25, as described above. The inner circumferential contour surface 25 is shaped to generally correspond to, but is sized slightly radially larger than, the circular outer circumferential surface 61 of the shaft portion 58 (i.e., R_{C}>R_{S}). As such, the shaft portion 58 is able to slidably displace through and is rotatably supported by the opening 22 such that the retainer axis 28 remains at a substantially fixed position. More specifically, the circular outer surface 61 of the shaft portion 58 slides closely against the circular inner surface 25/surface portion 27 of the retainer opening 22 such that the retainer axis 28 remains spaced from the second shaft outer surface 3 by the perpendicular distance D_{A}, as discussed above and indicated in FIGS. 2 and 13.

However, due the relative sizing of the clamp and shaft portions 56, 58, respectively, the clamp portion 56 fits within the opening 22 such that there is a relatively substantial clearance between the majority of the clamp portion outer surface 57 and the inner circumferential contour surface 25. Such clearance enables the clamp portion 56 to be readily displaced through the opening 22, but has the potentially adverse effect of allowing the clamp portion 56 to rotate about the retainer axis 28 as the retainer 14 displaces through the opening 22. As such rotation is not desired until the clamp portion 56 is disposed within the yoke channel 22 above the shaft portion 2a, the retainer 14 is preferably held at a specific position about the retainer axis 28 by a clip 68 (see. FIG. 10), as described below.

Although the above-described configurations of the retainer 14 are presently preferred, the retainer 14 may alternatively be constructed in any other appropriate manner that enables the shaft connector assembly 10 to function generally as described herein. For example, although the clamp portion 56 preferably has an elliptical or oval shape as discussed above, the clamp portion 56 may have any other appropriate shape, such as a substantially circular cylinder, a substantially circular cylinder having a separate projection providing the clamp surface 30, an axially tapered cylinder/tube, a cylinder/tube with an appropriate complex cross-sectional shape, etc. Further, the retainer body 62 may be formed of two or more separately attached components as opposed to three integrally formed portions 56, 58 and 60 described in detail above. The scope of the present invention encompasses these and all other appropriate structures of the retainer 14 that enable the shaft connector assembly 10 to function generally as described above and in further detail below.

Referring to FIGS. 3 and 10, the shaft connector assembly 10 preferably further comprises a clip 68 configured to maintain the second shaft portion 2a within the yoke channel 20 prior to clamping the retainer 14 against the shaft 2. In addition, with the second body structure 66, the clip 68 is also configured to releasably attach the retainer 14 to the yoke body 12, i.e., prior to engagement of the rod 16 with the retainer bore 26. The clip 66 is may be formed generally as a “slap yoke clip” disclosed in co-pending U.S. patent application Ser. No. 09/793,018, which is incorporated by reference herein. As such, a detailed description of the clip 68 is unnecessary and beyond the scope of the present disclosure, but a more limited description is herein provided for the sake of clarity. Basically, the clip 68 is formed as a generally rectangular plate 69 having a generally circular, central opening 70 and a plurality of deflectable, spring-like tabs or arms 71 spaced circumferentially about and extending into the opening 70. The deflectable arms 71 are configured to clampingly engage against the outer circumferential surface 63 of the head portion 60 when the retainer 14 is disposed within the clip opening 70 which either mounts the clip 68 to a retainer 14 with the first body structure 64 or to at least temporarily attach the retainer 14 with the second body structure 66 to the yoke body 12, as discussed in further detail below. Preferably, to retain the retainer head 60 spaced from the yoke wall 18A, as discussed below, the plate 69 is preferably modified from the structure as described in co-pending U.S. patent application Ser. No. 09/793,018, such that the plate 69 has two bended sidewall sections 69b formed so as to space the main portion 69a of the plate 69 from the outer surface of the sidewall 18A, as best shown in FIG. 10.

Referring particularly to FIG. 10, the clip 68 also includes an abutment portion or tab 72 and a retainer tab 73, each tab 72 and 73 integrally attached to a plate side edge 69c so as to extend generally perpendicularly to the remainder of the plate 69. The abutment tab 72 is disposable about an edge of the yoke body sidewall 18A and functions to locate the clip 68 with respect to the yoke body 12 during assembly of the retainer 14 to the yoke body 12. The retainer tab 73 extends partially across the U-shaped opening 17 into the yoke channel 20 and functions to temporarily retain the second shaft portion 2a disposed within the channel 20. More specifically, the retainer tab 73 has an angled edge 73a against which a second shaft 2 pushes when entering into the channel 20, so as to deflect or bend the tab 73 about the plate edge 69c and away from the opening 17, allowing the shaft 2 to become disposed within the channel 20. Then, the retainer tab 73 “snaps” back to extend across the opening 17 such that an inner edge 73b is contactable with the shaft outer surface 3 to temporarily hold the shaft 2 within the channel 20. Although the described clip 68 is preferred, the shaft connector assembly 10 may be provided with any appropriate clip or other device to connect the retainer 14 with the yoke body 12 prior to use. Further, the retainer 14 may be connected solely by friction between an appropriate portion of the retainer outer surfaces and the yoke retainer opening 22, as discussed above.

Furthermore, prior to using the shaft connector assembly 10 to connect the two shafts 1 and 2, the retainer 14 may be connected or coupled with the yoke body 12 in one of two different arrangements depending on the specific body structure 64 or 66, as discussed below. However, particularly with the second body structure 66, the retainer 14 may be coupled to the yoke body 14 after a shaft portion 2 is disposed within the channel 20. Referring to FIGS. 9 and 11, with a retainer body 62 formed in the first preferred structure 64, the retainer 14 is preferably coupled with the yoke body 12 by inserting the retainer 14 into the retainer opening 22 from the outer side of the yoke sidewall 18A. The retainer 14 is axially displaced through the opening 22 until the clamp portion 56 is fully disposed within the retainer opening 22, the shaft portion 58 extends outwardly from the sidewall 18A and the head portion 10 is spaced from the sidewall 18A. More specifically, the elliptical/oval-shaped outer circumferential surface 57 of the clamp portion 56 is closely fitted within the correspondingly shaped inner circumferential contour surface 23, preferably with generally a transitional or interference locational fit, with the clamp portion radial surface 59 being either flush with or recessed from the inner surface of the yoke sidewall 18A. As such, the retainer 14 is releasably attached to the yoke body 12 solely by friction between the outer surface of the clamp portion 56 and the inner surface of the retainer opening 22.

However, the clip 68 may be configured to releasably attach the retainer to the yoke body 12 to ensure that the retainer 14 is maintained at a fixed position, as discussed above. Such a clip configuration may be necessary if there is substantial clearance between the clamp outer circumferential surface 57 and the retainer opening 22, such that friction between these surfaces is minimal. The clip 68 is coupled with the retainer 14 and the yoke body 12 by first positioning the clip opening 70 against the outer surface of the head portion 60. Then, the clip 68 is pushed against the retainer 14 such that the head portion 60 enters the opening 70, bending the deflectable arms 71 until the arms 71 clampingly engage the about the head outer circumferential surface 63 and the locator tab 73 positions against the side edge of the yoke sidewall 18A. The clip 68 then functions to prevent the retainer 14 from displacing axially within the yoke retainer opening 22.

Referring to FIGS. 2, 10 and 12, with a retainer body 62 formed in the second preferred structure 66, the retainer 14 is coupled with the yoke body 12 in the following manner. The retainer 14 is inserted into the retainer opening 22 from the outer side of the yoke wall 18A until the clamp portion 56 extends from the inner surface of the sidewall 18A so as to be disposed within the yoke channel 20. The shaft portion 58 is then disposed within the yoke opening 22 and the head portion 10 is disposed generally against the outer surface of the yoke sidewall 18A, as shown in FIG. 2. Particularly when the retainer 14 is assembled to the yoke body 12 prior to inserting a shaft portion 2a into the yoke channel 20, the clip 68 is then preferably assembled onto the retainer 14 as described above. More specifically, the central opening 70 is generally aligned with the retainer head 60 and then the plate 69 is pushed toward the yoke sidewall 18A, such that the arms 71 engage about the head outer surface 63 to hold the retainer 14 in a generally fixed position with respect to the yoke body 12.

Referring particularly to FIG. 10, the clip arms 71 are configured to deflect a distance sufficient to enable the retainer 14 to displace outwardly along the retainer axis 28 such that the clamp portion 56 becomes disposed within the opening 22, while still remaining engaged with the head outer surface 63. Such a configuration of the clip 68 allows a second shaft 2 to displace the retainer 14 outwardly when entering the yoke channel 20, as discussed in further detail below, and thereafter enables the clip arms 71 to bias the retainer 14 back to the preferred initial position in which the clamp portion 56 is disposed within the yoke channel 20, as described above.

Referring now to FIGS. 2 and 9, the rod 16 is preferably a threaded rod, and most preferably a conventional bolt having a cylindrical body or shaft 74 with external threads 75 extending from a free end 74a of the shaft 74 and a head 76 disposed at the other shaft end 74b. The threads 75 are configured to mate with the threaded bore 26 of the retainer 14. Further, the rod 16 is most preferably a commercially available 8 mm bolt, but may alternatively be any other commercially available bolt of any appropriate size or a bolt specially manufactured specifically for use with the shaft connector assembly 10.

Alternatively, the rod 16 may be constructed without any threads, but may instead be provided with either one or more openings (i.e., slots, slotted openings, etc.) or one or more projections (i.e. such as keys, tabs, splines, etc.) configured to engage with mating projection(s) or opening(s) (none shown) of the retainer 14, preferably located within the retainer bore 26. With such an alternative construction of the connector assembly 10, the assembly 10 is preferably provided with an additional device or component to “lock” the rod 16 and the retainer 14 in a final position, such as an appropriate clip, key, pin, etc., in order to prevent the rod 16 from rotating within the rod opening 24 and moving the clamp surface 30 out of “clamping” contact with the shaft outer surface 3. The scope of the present invention encompasses these and any other alternative structures of the rod 16 and/or the retainer 14 that enable the connector assembly 10 to function generally as described herein.

Preferably, the yoke body 12 is stamped from low carbon steel, the clamp body 40 is cast from low carbon steel, the retainer 14 is forged and finish machined from low carbon steel and the threaded rod 16 is a forged and roll-threaded from low carbon steel. However, any or all of the components of the shaft connector assembly 10 may be formed of any other appropriate material, such as an alloy steel, an aluminum alloy, a polymeric material, etc., and/or formed by any other manufacturing technique, such as casting the yoke body 12, injection molding the retainer 14, etc. The scope of the present invention is in no manner limited by the materials used or manner of forming or fabricating the components of the shaft connector assembly 10.

Referring now to FIGS. 1-3 and 11-13, the shaft connector assembly 10 of the present invention is used to connect a first shaft 1 with a second shaft 2 in the following manner. As best shown in FIG. 3, the clamp body 42 is first attached to the first shaft 1 by inserting a shaft end portion 1a into the clamp body central opening 43 and then inserting and tightening a bolt (not shown) within the clamp portion openings 47, 49 so that the shaft portion 1a is tightly gripped within the clamp body 42. The connector assembly 10 may be connected with a first shaft 1 and then the coupled first shaft 1 and connector assembly 10 may be installed as a single unit into a final assembly position, for example within a steering system on an automobile chassis (neither shown), such that the connector assembly 10 is then ready for connection with the second shaft 2. Alternatively, the connector assembly 10 is attached to a first shaft 1 that is already located in such an assembly position. When assembled in any appropriate manner, the yoke body 12 is located so as to be relatively easily accessible to an assemblyperson or “assembler”. Next, the second shaft 2 is placed proximal to the rectangular opening 21 of the yoke body 12 and is then rapidly pushed or “slapped” upwardly so that the shaft 2a enters the yoke channel 20 through the lower, rectangular opening 21 until the shaft inner surface 4 is disposed against the base wall inner surface 19a and the remainder of the shaft 2 extends through the U-shaped opening 17.

With an assembly 10 having a retainer 14 constructed in first body structure 64, the shaft portion 2a merely slides past the retainer radial surface 59 (disposed generally flush with the inner surface of the yoke wall 18A) until the shaft inner surface 2b contacts the yoke channel base surface 19a. However, with an assembly 10 having a retainer 14 formed in the second body structure 66, since the clamp portion 56 is preferably disposed within the channel 20 as described above, the shaft 2 must “clear” the retainer 14 from the channel 20 in order for the shaft portion 2a to become fully disposed therein. As such, the shaft inner surface 2b pushes against the angled edge section 59a of the retainer clamp portion 56, such that the retainer 14 displaces outwardly from channel 20 through the retainer opening 22, as shown in FIG. 10. The retainer 14 moves against the biasing action of the clip deflectable arms 71 until the retainer clamp portion 56 becomes generally disposed within the sidewall opening 22. The clamp portion 14 remains located within the opening 22 until the shaft outer surface 2a displaces inwardly completely past the retainer radial surface 59, at which point the clip arms 71 bias the retainer 14 to move back through the retainer opening 22. The second shaft 2 thereby becomes disposed generally between the yoke channel base surface 19a and the retainer clamp portion 56. Thus, the second shaft portion 2a is temporarily and loosely retained within the channel 20 by both the retainer 14 and by the retainer tab 74 of the clip 68. With the first retainer body structure 64, the second shaft portion 2a is temporarily retained in the yoke channel 20 solely by action of the clip retainer tab 74, as discussed above.

Referring to FIGS. 2 and 9, the threaded rod 16 is inserted through the yoke rod opening 24 such that the rod 16 extends across the yoke channel 20 until the rod free end 74a enters the retainer bore 26. As best shown in FIG. 9, the rod 16 is rotated into threaded engagement with the bore 26, such that the retainer and rod axes 28, 32, respectively, become generally collinear, and the rod free end 74a then displaces along the rod axis 32 generally toward, and preferably through, the first opening 22. The rod free end 74a continues to displace through the bore 26 until the rod head 76 becomes disposed against the pressure surface 19 about the yoke rod opening 24, as shown in FIG. 2, thereby preventing further linear displacement of the rod 16. At this point, with a retainer 14 having the second body structure 66, the retainer clamp portion 56 is already disposed generally completely within the yoke channel 20, as described above, such that further angular or rotational displacement of the rod 16 about the rod axis 32 angularly displaces the retainer 14 about the rod axis 32. Such angular displacement of the retainer 14 linearly displaces the clamp surface 30 into contact with the shaft outer surface 3, as discussed above and in further detail below.

However, with a retainer 14 having the first body structure 64, rotation of the rod 16 after the rod head 76 becomes disposed against the pressure surface 19 first “pulls” the retainer clamp portion 56 through the yoke retainer opening 22 such that the retainer 14 linearly displaces along the rod axis 32. More specifically, angular displacement of the rod 16 in a first rotational direction R₁ about the rod axis 32 displaces the retainer 14 in a first linear direction L₁ along the axis 32 generally toward the yoke rod opening 24 and the second sidewall 18B, as indicated in FIG. 9. When the clamp portion 56 is completely disposed within the yoke channel 20, further rotational displacement of the rod 16 then rotates or angularly displaces the retainer 14 about the rod axis 32 and into contact with the second shaft 2.

Referring to FIGS. 11-14, with either retainer body structure 64 or 66, when the retainer clamp portion 56 becomes disposed within the channel 20, the retainer shaft portion 58 is located within the first opening 22 and the clamp surface 30 is initially spaced from (i.e., vertically beneath) the shaft outer surface 3, as best shown in FIGS. 11 and 12. With the retainer 14 so positioned, angular displacement of the rod 16 about the axis 32 then causes the retainer shaft portion 58 to rotate within the opening 22, thereby angularly displacing the clamp portion 56 about the rod axis 32 until the clamp surface 30 linearly displaces into contact with the shaft outer surface 3. Referring particularly to FIGS. 13 and 14, a portion or point Cₙ on the clamp surface 30 contacts the shaft outer surface 3 at a contact point P_{Cn} spaced generally along the shaft centerline 4 from the rod axis 32 by a substantial (i.e., more than negligible) distance dₙ, as described above. In other words, the rod axis 32 is spaced perpendicularly from one point P₁ on the shaft centerline 4 and the clamp contact point P_{Cn} is spaced perpendicularly from a second point P₂ on the centerline 4, the two points P₁, P₂ being spaced apart by the distance d_{Cn}. It must be noted that the term “point” is used herein for convenience to indicate positions on the retainer clamp surface 30, the shaft outer surface 3, and the interface between the two surfaces 3 and 30, but actually refer to generally linear portions or sections of each surface 3 or 30 that extend generally axially with respect to the retainer and rod axes 28, 32, respectively.

Referring specifically to FIG. 13, when the clamp surface 30 is in contact with the shaft outer surface 3 such that further rotation of the rod 16 is substantially prevented, torque T applied to the rod 16 is then transmitted to the retainer 14, through the engagement of the threaded bore 26 and the rod threads 75. Such torque T applied to the retainer 14 causes the clamp surface 30 to push or clamp against the shaft outer surface 3, as indicated in FIG. 13. Due to the spacing of the clamp surface contact point P_{C} from the rod axis 32 by the “axial” (i.e., along the centerline 4) distance d_{C} as described above, the clamp surface 30 is able to generate a normal force F that is applied to the shaft portion 2a at the contact point P_{C}. The normal force F causes the shaft inner surface 5 to push against the yoke base inner surface 19a to thereby positively retain the shaft portion 2a within the yoke channel 20. If the interface between the clamp surface 30 and the shaft outer surface 3 was generally centered about a point P_{B} located directly between the rod axis 32 and the shaft centerline 4 (i.e. d_{C}=0), torque applied to the rod 16 could not generate a normal force F directed toward the base surface 19a. As such, the retainer 14 would then only retain the shaft 2 by friction or an interference fit, which are the mechanisms employed by previously known shaft connector devices.

Referring to FIGS. 11, 13 and 14, the connector assembly 10 is adjustable to accommodate a plurality of second shafts 2 of different thickness tₙ due to the combined effect of the clamp surface 30 having a varying radius Rᵥ and the arrangement of the clamp surface 30 being initially spaced from the shaft outer surface 3. Specifically, when the rod 16 causes the retainer 14 to angularly displace about the rod axis 32, the clamp surface 30 linearly displaces toward the shaft 2 until a point Cₙ on the clamp surface 30 contacts the shaft outer surface 3, as discussed above. Depending on the thickness tₙ of the particular second shaft 2, and thus the initial spacing distance Sₙ between the clamp surface 30 and the shaft surface 3, a different one of a plurality of points Cₙ on the clamp surface 30 contacts the shaft surface 3 to retain the shaft 2 within the yoke body 12, as discussed below. Further, the particular values of the angular displacement Aₙ of the retainer 14 (i.e., when rotatably displacing into contact with the shaft 2) and the linear displacement dₙ of the specific surface point Cₙ which contacts the shaft 2, as well as the particular location of the contact point P_{Cn} on the shaft 2, each vary depending on the shaft thickness tₙ.

For example, referring to FIG. 13, with a second shaft 2 having a relatively lesser thickness t₁, the clamp surface 30 is spaced a greater initial distance S₁ from the shaft outer surface 3 such that the retainer 14 must rotate through a relatively greater angular displacement A₁ about the rod axis 32 in order to contact the second shaft 2. A first clamp surface point C₁, located at a relatively greater radial distance R₁ about the axis 28, linearly displaces through a relatively greater distance d₁ (i.e., indicated by a perpendicular spacing distance) to contact the shaft surface 3. When in contact with such a “thinner” shaft 2, the clamp surface point C₁ is disposed against a shaft surface contact point P_{C1} that is spaced a relatively lesser distance d_{C1}, along the centerline 4 from the rod axis 32. Referring to FIG. 14, on the other hand, with a second shaft 2 having a relatively greater thickness t₂, the retainer 14 (initially spaced a lesser distance S₂) rotates through a lesser angular displacement A₂ to displace a different or second clamp surface point C₂, located at a lesser radial distance R₂, through a lesser linear distance d₂ into contact with the shaft surface 3. When the retainer 14 is in contact with such a “thicker” shaft 2, the clamp surface point C₂ is disposed against a shaft surface contact point P_{C2} that is spaced from the rod axis 32 by a relatively greater distance d_{C2} along the centerline 4.

Further, the connector assembly 10 of the present invention is able to retain any second shaft 2 having a thickness dimension tₙ within a range of thickness from a maximum thickness t_{MAX} to a minimum thickness t_{MIN}, as indicated in FIG. 11. More specifically, with a second shaft 2 having the minimum thickness t_{MIN}, the radially-outermost surface point C₀ (i.e., from the axis 28) contacts the shaft surface 3 at a point P_{C0} located a least or shortest distance d_{C0} along the centerline 4 with respect to the rod axis 32. Also, with a second shaft 2 having the maximum thickness t_{MAX}, the radially-innermost surface point C₁ contacts the shaft surface 3 at a point P_{C1} located a greatest distance d_{C1} along the centerline 4 with respect to the rod axis 32. Further, the actual values of the maximum and minimum shaft thickness t_{MAX}, t_{MIN} retainable by the shaft connector 10 depend on the value of the distance between the retainer axis 28 and yoke base surface 19a, the value of the outer diameter D_{C} of the retainer clamp portion 56 and the actual shape of the clamp portion 56.

The shaft connector 10 of the present invention has a number of advantages over previously known shaft connector devices. By having the capability of retaining various second shafts 2 of different thickness tₙ, as may result from “generous” manufacturing tolerances, the connector assembly 10 is able to compensate for such shaft variations and enable connection of any actual pair of first and second shafts 1, 2, respectively. Further, by engaging the second shaft 2 with a normal force F (see FIG. 13) applied through the clamp surface 3, the connector assembly 10 more positively fixes the position of the second shaft 2 with respect to the yoke body 12 as compared to previous designs that rely on a friction or interference fit. Furthermore, by having the retainer 14 disposed within the retainer opening 22 prior to assembly of the second shaft 2, an assembler only has to insert the rod 16 through the rod opening 24 and then rotate the rod 16 until the retainer 14 is clamped against the shaft outer surface 3, such that all assembly steps performed on the connector assembly 10 are performed from only one side of the yoke body 12. As the space available for connecting automotive shafts 1 and 2 in a final assembly position is typically minimal, the described assembly method provides a great advantage over previous connector devices where a bolt is inserted from one side of the yoke body and a nut is assembled from the other yoke body side.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A shaft connector for connecting a first shaft with a second shaft, the shaft connector comprising:
a body having an end portion connectable with the first shaft, a channel configured to receive a portion of the second shaft, a first opening into the channel and a second opening into the channel generally aligned with the first opening;
a retainer at least partially disposed within the first opening and having a bore; and
a rod disposable through the second opening, having a longitudinal axis and being engageable with the retainer bore so as to at least one of displace the retainer along the rod axis and alternatively rotate the retainer about the rod axis such that the retainer contacts the second shaft to retain the second shaft portion disposed within the body channel.

2. The shaft connector assembly as recited in claim 1 wherein the retainer is configured such that when the rod is engaged with the bore, rotational displacement of the rod about the rod axis linearly displaces the retainer along the rod axis so that a portion of the retainer displaces through the first opening and alternately rotates the retainer about the rod axis so as to contact the second shaft.

3. The shaft connector assembly as recited in claim 2 wherein rotational displacement of the rod in a first direction displaces the retainer in a first linear direction generally along the rod axis and generally toward the second opening.

4. The shaft connector assembly as recited in claim 1 wherein the retainer includes a clamp surface contactable with the second shaft and a shaft portion, the shaft portion being disposed within the first opening when the clamp surface is in contact with the shaft.

5. The shaft connector assembly as recited in claim 1 wherein the retainer has a generally cylindrical body having an axis, the retainer bore extending at least partially through the body so as to be generally centered about the retainer axis, the body including a clamp portion having an oblong cross-sectional shape in a plane extending generally perpendicular to the retainer axis and a shaft portion connected with and spaced from the clamp portion along the retainer axis, the shaft portion having a generally circular cross-sectional shape in a plane extending generally perpendicular to the retainer axis.

6. The shaft connector assembly as recited in claim 5 wherein the retainer body further includes a generally circular head portion spaced from the shaft portion along the retainer axis such that the shaft portion is disposed between the clamp portion and the head portion, the head portion being sized radially larger than the shaft portion.

7. The shaft connector assembly as recited in claim 5 wherein the first opening is configured to permit the clamp portion to slidably displace through the opening and to permit the shaft portion to rotatably displace within the opening.

8. The shaft connector assembly as recited in claim 5 wherein the first opening has an oblong contour surface substantially corresponding in shape to the oblong cross-section of the clamp portion and sized such that the retainer is slidably displaceable through the first opening, the oblong contour surface having a partially circular portion providing a bearing surface configured to rotatably support the shaft portion.

9. The shaft connector assembly as recited in claim 5 wherein the first opening has a generally circular contour surface substantially corresponding in shape to the shaft portion and sized to rotatably support the shaft portion.

10. The shaft connector assembly as recited in claim 1 wherein the retainer has an axis extending longitudinally through the bore and an outer clamp surface spaced from the retainer axis and contactable with the shaft outer surface.

11. The shaft connector assembly as recited in claim 10 wherein the second shaft has a longitudinal centerline and the clamp surface is contactable with the shaft outer surface at a position spaced from the rod axis by a substantial distance generally along the second shaft centerline.

12. The shaft connector assembly as recited in claim 1 wherein the yoke channel is configured to separately receive a portion of each one of a plurality of second shafts and an angular position of the retainer about the rod axis is adjustably variable to separately retain each one of the portions of the plurality of second shafts within the yoke channel.

13. The shaft connector assembly as recited in claim 12 wherein:
each of the plurality of second shafts has two opposing outer surfaces spaced apart by a thickness dimension, the thickness dimension of each second shaft having a value different than a value of the thickness dimension of each one of the remaining second shafts;
the yoke body further includes a base wall the yoke channel is configured to separately receive each one of the second shaft portions such that one of the two shaft outer surfaces is disposed generally against the base wall and the other one of the two shaft outer surfaces is disposed generally proximal to the retainer; and
the rod adjustably positions the retainer about the rod axis such that the retainer is contactable with the proximal shaft outer surface of the shaft portion so as to retain the shaft portion within the yoke channel.

14. The shaft connector assembly as recited in claim 1 wherein the second shaft has an outer surface, the retainer has a longitudinal axis extending through the bore, and the retainer further has a clamp surface spaced radially from the retainer axis and contactable with the second shaft outer surface when the second shaft is disposed within the yoke channel such that torque applied to the rod is transmitted to the retainer to cause the clamp surface to push against the shaft outer surface.

15. A shaft connector assembly for connecting a first shaft with a second shaft, the second shaft having an outer surface and a longitudinal centerline, the shaft connector comprising:
a yoke body having an end portion connectable with the first shaft, a channel configured to receive a portion of the second shaft, and a wall with an opening;
a threaded rod disposable through the yoke opening and having a longitudinal axis; and
a retainer having a threaded bore, a longitudinal axis extending through the bore, and a clamp surface spaced radially from the retainer axis, the bore being threadably engageable by the rod such that the rod axis is generally collinear with the retainer axis and rotation of the rod about the rod axis causes the clamp surface to push against the second shaft outer surface so as to retain the second shaft portion disposed within the yoke channel, the clamp surface contacting the shaft outer surface at a position spaced from the rod axis by a substantial distance generally along the second shaft centerline.

16. The shaft connector assembly as recited in claim 15 wherein when the clamp surface is in contact with the shaft outer surface, the rod axis is spaced perpendicularly from a first position on the second shaft centerline and the clamp surface has a geometric center spaced perpendicularly from a second position on the second shaft centerline, the first and second positions being spaced apart axially along the centerline.

17. The shaft connector assembly as recited in claim 15 wherein when the rod is engaged with the retainer bore, torque applied to the rod is transmitted to the retainer to cause the clamp surface to push against the shaft outer surface.

18. The shaft connector assembly as recited in claim 15 wherein the yoke has another wall with an opening, the retainer being at least partially disposed within the other wall opening and when the rod is engaged with the retainer bore, angular displacement of the rod about the rod axis linearly displaces the retainer along the rod axis such that a portion of the retainer displaces through the sidewall opening and alternatively rotates the retainer about the rod axis.

19. The shaft connector assembly as recited in claim 15 wherein the retainer has a generally cylindrical body including a first body portion, the first body portion having an oblong cross-sectional shape in a plane extending generally perpendicularly with respect to the retainer axis, and a second body portion connected with and spaced along the retainer axis from the first body portion, the second body portion having a generally circular cross-sectional shape in a plane extending generally perpendicularly with respect to the retainer axis.

20. The shaft connector assembly as recited in claim 19 wherein the other sidewall opening has an oblong contour substantially corresponding in shape to the oblong cross-section of retainer first body portion and sized such that the retainer is slidably displaceable through the other wall opening, the oblong contour having a partially circular portion providing a bearing surface configured to permit the retainer second body portion to angularly displace within the other wall opening.

21. The shaft connector assembly as recited in claim 19 wherein the other wall opening has a generally circular contour surface substantially corresponding in shape to the retainer second body portion and sized to rotatably support the retainer second body portion.

22. The shaft connector assembly as recited in claim 21 further comprising a clip connected with the retainer and configured to bias the retainer toward the yoke wall.

23. The shaft connector assembly as recited in claim 15 wherein the yoke channel is configured to separately receive a portion of each one of a plurality of second shafts and an angular position of the retainer about the rod axis is adjustably variable to separately retain each one of the portions of the plurality of second shafts within the yoke channel.

24. The shaft connector assembly as recited in claim 23 wherein:
each of the plurality of second shafts has two opposing outer surfaces spaced apart by a thickness dimension, the thickness dimension of each second shaft having a value different than a value of the thickness dimension of each one of the remaining second shafts;
the yoke body further includes a base wall extending between the sidewalls and the yoke channel is configured to separately receive each one of the second shaft portions such that one of the two shaft outer surfaces is disposed generally against the base wall and the other one of the two shaft outer surfaces is disposed generally proximal to the retainer; and
the rod adjustably positions the retainer about the rod axis such that the retainer is contactable with the proximal shaft outer surface of the shaft portion so as to retain the shaft portion within the yoke channel.

25. An adjustable shaft connector for connecting a first shaft with a second shaft selected from a plurality of second shafts, each second shaft having a thickness dimension different than the thickness dimension of each other second shaft, the shaft connector comprising:
a body having an end portion connectable with the first shaft, a channel configured to receive a portion of the selected second shaft, a first opening into the channel and a second opening into the channel generally aligned with the first opening;
a rod disposable through the second opening and having a longitudinal axis; and
a retainer at least partially disposed within the first opening and having a bore engageable by the rod and a clamp surface spaced radially from the bore, the retainer being configured to rotatably displace about the rod axis when the rod rotates within the second opening such that the clamp surface linearly displaces by a distance so as to contact and retain the selected second shaft disposed within the body, a value of the distance for the selected shaft being different than another value of distance for each other one of the plurality of second shafts.
